(19) United States
(12) Patent Application Publication
(10) Pub. No.: US 2004/0210488 A1
(43) Pub. Date: Oct. 21, 2004

(54) Internet Pharmacy Dispenser

(76) Inventor: James M. Doherty, Georgetown, TX (US)

Correspondence Address: LACASSE & ASSOCIATES, LLC, 1725 DUKE STREET, SUITE 650, ALEXANDRIA, VA, 22314, US

(21) Appl. No.: 10/249,547

(22) Filed: Apr. 17, 2003

(51) Int. Cl. G06F 17/60

(52) U.S. Cl. 705/22

(57) ABSTRACT

A mechanized, monitored pharmacy dispensing service and device that provides positive feedback to administrator(s) (doctors, pharmacists, patient care providers, family members, etc.) over a network such as the Internet (via a wireless connection). The device comprises a single board computer that communicates with a medical server and a plurality of pill cylinders which allow for dispensing of a large quantity of medication, which must be taken in a particular sequence at a particular time, as defined by the administrator(s). A sensor for detecting that the dose of medication has been dispensed as well as removed from the dispenser receiver allows an administrator to monitor the patient. A positive confirmation button may also be present so that a patient can confirm the dispensed medicine has been taken.

### BACKGROUND OF INVENTION

1. Field of Invention

The present invention relates generally to the field of medication dispensers. More specifically, the present invention is related to medication dispensers that monitor and provide feedback in real-time.

2. Discussion of Prior Art

When patients are prescribed medications, it is important that they follow the recommended dosage and instructions as provided by the health care provider. Some patients, such as the elderly or cancer patients, are required to take large quantities of medication in a particular sequence daily. Because of the strict regimen that these patients must follow, dispensers are provided that aid in reminding the patient when to take the medication.

Typical devices use a memory device to record medication information, such as when the dosage was dispensed. This information can then be sent to an administrator, such as a doctor or another person, via a port or cellular connection, for example, to monitor the administration of the dosage, and, ideally, patient compliance. However, the use of a memory device does not allow the patient and administrator to actively interact. Because it is important for some patients to take a particular dosage of medication(s) at a particular time(s), it is important that the monitoring of the dispensing of the medication and when the medication is taken to be in real-time. Further, patient information, medication history, and prescriptions should be actively updated to provide positive feedback to both the patient and concerned party(ies) (administrator, doctor, nurse, pharmacist, family member, etc.).

Because the medication device needs to be periodically filled with the correct prescription (preferably by an administrator), it is essential that the medication device is easily transportable. Further, which prescription is required, as well as when the dispenser is filled, should be stored as part of the patient's file. One of the problems with traditional dispensers is the necessity of a port, telephone line, or cellular connection nearby so that a physical connection can be made. If the device is not connected, it is unable to transmit information in real-time and unable to provide positive feedback. A wireless connection, therefore, provides added benefits of allowing real-time interaction and direction such as when to dispense medication, when to refill, the correct prescription, etc.

One popular method of implementing a wireless connection is based upon the IEEE 802.11 standard. 802.11 refers to a family of specifications developed by the Institute of Electrical and Electronics Engineers (IEEE) for wireless local area network (LAN) technology. 802.11 specifies an over-the-air interface between a wireless client and a base station or between two wireless clients. There are several specifications in the 802.11 family, some of which are described below:

802.11 applies to wireless LANs providing 1 or 2 Mbps transmission in the 2.4 band using either frequency hopping spread spectrum (FHSS) or direct sequence spread spectrum (DSSS).

802.11a an extension to 802.11 that applies to wireless local area networks (LANs) and provides up to 54 Mbps in the 5 GHz band. 802.11a uses an orthogonal frequency division multiplexing encoding scheme rather than FHSS or DSSS.

802.11b also referred to as 802.11 High rate or Wi-Fi (for wireless fidelity), formed as a ratification to the original 802.11 standard, allowing wireless functionality comparable to the Ethernet. This is an extension to 802.11 that applies to wireless LANs and provides 11 Mbps transmission (with fallback to 5.5, 2, and 1 Mbps) in the 2.4 GHz band. Transmission in the 802.11b standard is accomplished via DSSS.

802.11g applies to wireless LANs and provides 20+ Mbps in the 2.4 GHz band.

The most popular of the above standards is the 802.11b.

The following references provide examples of medication dispensers used in a patient's home:

The patent to Rose (U.S. Pat. No. 4,695,954) provides for a medication dispensing system and apparatus that utilizes a portable memory device. The dispenser is programmed to distribute medications to a patient at prescribed times by using the information that is programmed in the memory device. Patient compliance information is stored within the memory device and can be accessed by hospital personnel through a monitor.

The patent to Fedor et al. (U.S. Pat. No. 6,163,737), assigned to Diebold, Incorporated, provides for a medical item dispensing apparatus that holds a plurality of medical vials and dispenses medical items through gate members. A data terminal is activated in response to the selection of an item and provides a single unit dose of the particular item requested. The system may also verify that the user is an authorized user.

The patent to McKinnon et al. (U.S. Pat. No. 6,202,642 B1), assigned to Medtrac Technologies, Inc., provides for an electronic monitoring medication apparatus and method. The system includes a medicine canister containing medication to be dispensed (such as an asthma inhaler) and an actuator that houses the canister and an adapter assembly. A speaker can produce an alarm when a dose of medication is required. After dispensing, the system communicates with a docking station to retrieve the data stored in a memory device in the adaptor assembly, and reprogramming of the system takes place.

The patent to de la Huerga (U.S. Pat. No. 6,259,654), assigned to Telaric, L.L.C., provides for an organizer and dispenser of multi-vial medication. Different types of medication vials have machine readable memory devices in the lids that determine when each medication is to be taken and signals the patient to take the appropriate medication from the appropriate vial at the appropriate time. Information on memory strips present on the lids can be transmitted to a hospital or nursing home computer.

The patent application publication to Kulkarni (2001/0032098 A1) provides for an Internet ready medical device. Disclosed is a method and apparatus for acquiring data, particularly data related to a person's health care habits. For example, a pillbox is retrofitted with electronic circuitry that records the opening and closing of the pillbox. When the pillbox is opened, an information signal is transmitted by transmission means to a remote central data server. Furthermore, the pillbox includes hardware for establishing an Internet connection.

In all of the above systems, there is no mention of monitoring and controlling devices over a wireless network in real-time while providing feedback. Whatever the precise merits, features, and advantages of the above-cited references, none of them achieves or fulfills the purposes of the present invention.

### SUMMARY OF INVENTION

A medication dispenser is wirelessly connected to a network in order to provide real-time control and feedback to an administrator(s) regarding dispensing of medication and patient compliance when medication is dispensed. The mechanized device comprises a single board computer and a plurality of pill cylinders which are filled with a particular amount of medication (as defined by the administrator(s)). The dispenser is used for dispensing large quantities of medication. The single board computer of the dispenser communicates with a medical server via a local gateway device. When a particular medication must be administered, the appropriate pill cylinder is dispensed at the time the medication must be taken. A sensor in a receiver, such as a tray or cup, detects the dispensing of the medication and, preferably, an alarm is activated to alert the patient that medication has been dispensed. Further, the administrator(s) is alerted that the medication has been dispensed to the patient. Once taken, the sensor again informs the administrator(s) that the medication has been removed. The patient can confirm that the medication has been taken by pressing a button on the device. If, however, the medication is not removed or the patient does not confirm that the medication was taken, an alarm is activated to alert the administrator(s) of such.

### BRIEF DESCRIPTION OF DRAWINGS

FIG. 1 illustrates a system diagram of the preferred embodiment of the medication pharmacy dispenser.

FIG. 2 illustrates a method of establishing service with the preferred embodiment.

FIG. 3 illustrates the system process after the medication has been dispensed.

### DESCRIPTION OF THE PREFERRED EMBODIMENTS

While this invention is illustrated and described in a preferred embodiment, the device may be produced in many different configurations, forms, and materials. There is depicted in the drawings, and will herein be described in detail, a preferred embodiment of the invention, with the understanding that the present disclosure is to be considered an exemplification of the principles of the invention and the associated functional specifications for its construction and is not intended to limit the invention to the embodiment illustrated. Those skilled in the art will envision many other possible variations within the scope of the present invention.

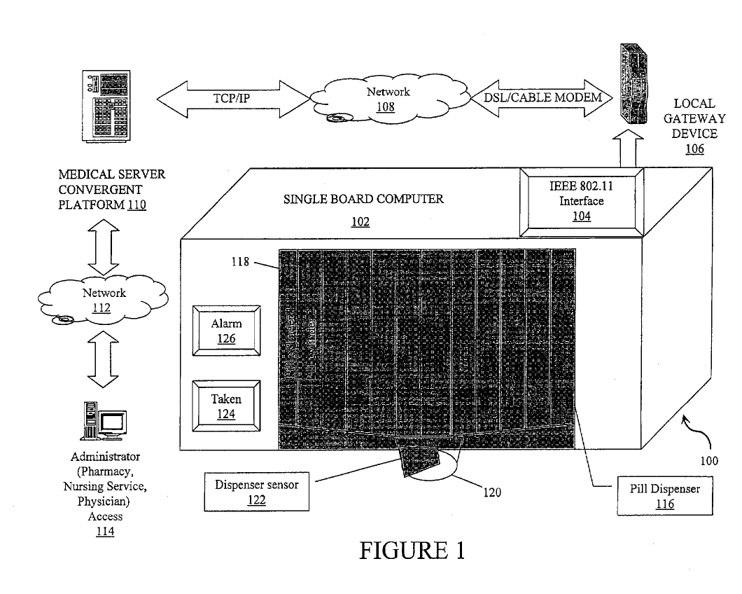

FIG. 1 illustrates the preferred embodiment of the invention. Medication dispenser 100 is a portable device comprising single board computer 102 and pill dispenser 116. Single board computer 102 connects to local gateway device 106, preferably via IEEE 802.11 interface 104. Local gateway 106 is any one of several commercially available 802.11 wireless access points. Although FIG. 1 illustrates only a single local gateway, it is envisioned that single board computer 102 is able to communicate wirelessly with a plurality of gateways dispersed at a number of predetermined remote physical locations, and the gateways are able to communicate with a server over a network (discussed below). Each of these has a CPU and is a single board computer with an HTTP/HTML interface. In this system, the medication dispenser service would negotiate with a gateway provider to allow this service to be enabled. The 802.11 gateway would then send the billing information to the billing server and open the appropriate TCP/IP ports for medication dispenser 100 to communicate with medical server platform 106. The gateway would also allow medical dispenser 100 to be configured through an, HTTP/HTML interface.

Medication dispenser 100 exchanges information in real-time with medical server platform 110 through network 108 via methods such as a DSL/cable modem, TCP/IP connection, etc. Server 110 is designed to send and receive parameters associated with the patient and medication dispenser 100 via gateway 106. For example, administrators can monitor 114 the patient's compliance, write a prescription, and provide information for a pharmacy to fill the dispensers through a network. Therefore, the exchanged information may be registration (registering the device with the system), prescription filling, dispensing of medication, taking dispensed medication, and other data regarding a patient. More importantly, the system provides positive feedback that is available to a doctor, pharmacy(ies), nursing service, physician(s), or family hereinafter “administrator” who can access patient information 114 in medical server platform 110 through network 112. Networks 108 and 112 can be any of, but not limited to: a local area network (LAN), a wide area network (WAN), a wireless network, telephony-based network, or the Internet. In the preferred embodiment, networks 108 and 112 utilize the Internet.

Although medication dispensing device 100 of this invention is designed to be mechanized, the specific working parts of the device are beyond the scope of this invention. However, specific features of the device aid in the monitoring of patient compliance. Provided in pill dispenser 116 are pill cylinders 118 designed to be filled with appropriate medication. Receiver 120, such as a tray or cup, is designed to receive the dispensed medication. Provided in receiver 120 is dispenser sensor 122. Dispenser sensor 122 is provided to detect when medication is present in receiver 120. In the preferred embodiment, as medication is dispensed, the sensor communicates the detection of medication in the receiver to the single board computer, which in turn communicates to the server that the medication has been dispensed, allowing the administrator to see what time the medication was dispensed. After the user removes the medication from the receiver, the sensor detects the absence of the medication and, again, communicates the information, and the system notes and records that the medication has been removed. If, however, after a message that the medication has been dispensed, sensor 122 does not respond within a predefined “time out” interval, an alert is sent to the administrator to indicate that the medication has not been removed from receiver 120. Further, button 124 may be provided on the medication device that allows the patient to confirm the dispensed medication was taken. After sensor 122 detects that the dispensed medication has been removed, again, if the patient does not push the taken button 124 within a predefined “time out” interval, the administrator receives an alert message, much like any network management system.

An additional alarm 126 may be provided on the device that is activated to inform the patient that the medication has been dispensed and should be taken. Alarm 126 may be, but is not limited to, a light, sound device, voice message, or combination thereof.

Because dispenser 100 is portable, it allows a person to easily transport the device to a pharmacy to fill a prescription. Pill cylinders 118 are filled by a pharmacist or similar administrator with the appropriate medication and appropriate dosage. An 802.11 interface 104 in medication device 100 aids not only in the accuracy of real-time communication with medical server platform 110 when medication is dispensed and taken, but also when prescriptions are filled. If a pharmacy has an 802.11 gateway available, medical server 110 will be notified by the dispenser's 100 self registration capabilities when the pharmacist reloads the pill cylinders. When the pharmacist reloads pill cylinders 118 of medication dispenser 100, if he has an 802.11 gateway available, the medical server 110 will be notified by the unit's self registration capabilities.

Since a pharmacist or an administrator fills dispenser 100, the patient does not need to be concerned about taking the wrong quantity of medication at the incorrect time. For example, a patient may be required to take X number of medication A at 9:00 a.m., and Y number of medication B at 12:00 p.m. The pharmacist or administrator fills cylinders 118 with the proper medication, and the sequence in which the medication is to be dispensed is downloaded from medical server 110 through network 108 to single board computer 102. The medication in appropriate cylinder 118 is then dispensed at the appropriate time, and the system proceeds as described above.

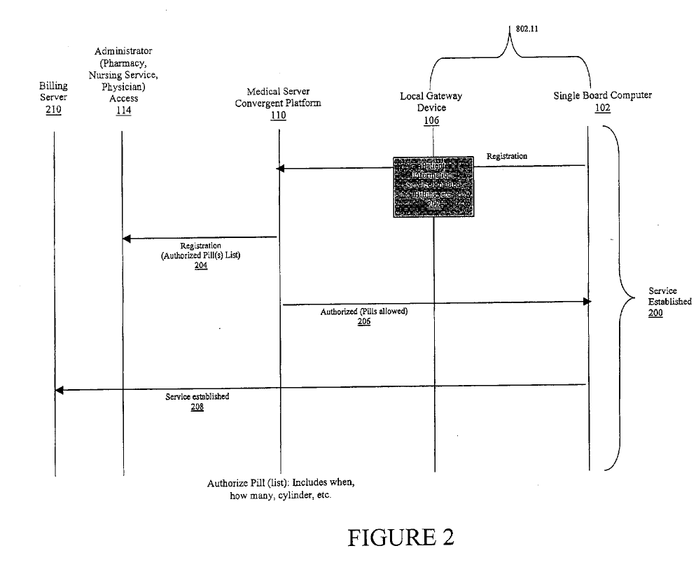

FIG. 2 illustrates a method of the interaction between the elements of the system when the medication dispensing device is being registered. In order to establish service 200, a patient registers 202 through the single board computer of the medication dispenser with the medical server platform through a local gateway. The device, patient, billing, and service information, for example, is enabled. The medical server contacts 204 the administrator to establish registration and obtain the authorized information, such as the pill(s) list. After registration, the administrator then authorizes a prescription for the device through the server, and the server sends 206 the authorized prescription to the single board computer. After the device is registered and confirmed by the administrator, service is established 208 with a billing server 210.

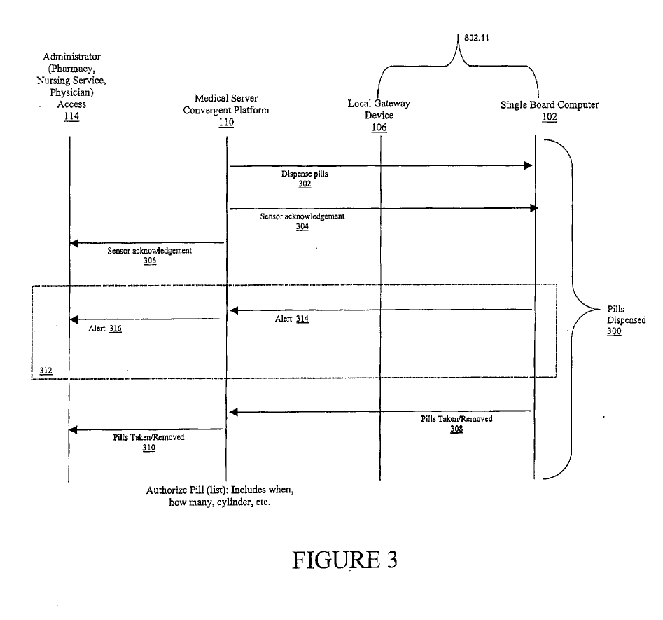

FIG. 3 illustrates the process implemented between the elements of the system after the prescription has been dispensed 300 by the medication dispenser. When it is time for a patient to take medication, the medical server contacts 302 the single board computer of the medical device to dispense the appropriate medication (of the appropriate cylinder). After the medication has been dispensed, a sensor acknowledges 304 that the pills are in the receiver. Further, the administrator is alerted 306that pills have been dispensed and are located in the receiver. Alternatively, an alarm present on the device may be activated to alert the patient that the medication is waiting to be taken (not shown). After the medication has been removed 308 (that is, the sensor detects the absence of the pills that were recently dispensed), an alert is again sent 310 to the administrator that the patient has taken the medication.

As previously mentioned, the sensor has a predefined “time out” interval for the patient to respond. The single board computer of the medication dispensing device can notify the administrator of other alerts using this interval, as shown by box 312. For example, if the patient does not remove the medication during the “time out” interval, an alert is sent 314 to the medical server, which in turns sends 316 an alert to the administrator to indicate that the medication has not been removed from the receiver. The administrator may then take appropriate action. Alternatively, and as previously mentioned, a button may be provided on the medication device that allows the patient to confirm that the medication dispensed and removed from the receiver was taken. After the sensor detects that the dispensed medication has been removed, and the patient does not push the taken button within a predefined “time out” interval, the administrator may similarly receive an alert message indicating that the button has not been pushed to confirm that the medication was physically taken.

Conclusion

A system and method has been shown in the above embodiments for the effective implementation of an Internet pharmacy dispenser. While various preferred embodiments have been shown and described, it will be understood that there is no intent to limit the invention by such disclosure but, rather, it is intended to cover all modifications and alternate constructions falling within the spirit and scope of the invention, as defined in the appended claims. For example, the present invention should not be limited by software/program, computing environment, and/or specific computing hardware.

The above enhancements for an Internet pharmacy dispenser and its described functional elements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of medication dispensing.

1. A mechanized medication dispensing device, said device comprising:
a plurality of pill cylinders, said cylinders holding medication defined by a set of medication dispenser parameters,
a pill receiver, receiving dispensed medication from said pill cylinders,
a single board computer communicating wirelessly with a gateway device,
said gateway device operatively linked with a server over a network, and
wherein said parameters define one or more of: the type of medication,
quantity of medication, and dispensing schedule of medication.

2. A mechanized medication dispensing device, as per claim 1, wherein the receiver further comprises at least one sensor detecting the presence of medication in the pill receiver.

3. A mechanized medication dispensing device, as per claim 1, wherein the device further includes an alarm to alert a patient that medication has been dispensed into the receiver.

4. A mechanized medication dispensing device, as per claim 1, wherein said alarm includes one or more of: a light, sound device, voice message.

5. A mechanized medication dispensing device, as per claim 1, wherein the device further includes a confirmation button for the patient to confirm that the dispensed medication has been taken.

6. A mechanized medication dispensing device, as per claim 1, wherein said wireless communication is via an IEEE 802.11-based interface.

7. A mechanized medication dispensing device, as per claim 1, wherein said network comprises any of the following: a local area network (LAN), a wide area network (WAN), a wireless network, a telephony-based network, or the Internet.

8. A method providing bi-directional real-time network-based control and feedback of a medication dispensing device, said method comprising:
wirelessly receiving medication dispenser parameters from a server via a gateway, tracking and recording information regarding dispensed medication wirelessly transmitting in real-time to said server, via a gateway, said tracked and recorded information, and
wherein said information is utilized by one or more clients having access to said server to provide feedback and control to said medication device.

9. A method providing a bi-directional real-time network-based control and feedback of a medication dispensing device, as per claim 8, wherein said parameters define one or more of: the type of medication, quantity of medication, and dispensing schedule of medication.

10. A method providing a bi-directional real-time network-based control and feedback of a medication dispensing device, as per claim 8, wherein said wireless communication is via an IEEE 802.11-based interface.

11. A method of wirelessly communicating medication dispenser parameters for a medication dispenser device registered with a server, from one or more administrators to said medication dispenser device, said method as implemented by the server comprising the steps of:
receiving via a first network parameters from one or more clients having access to said server, wherein said parameters define at least the type of medication, quantity of medication, and dispensing schedule of medication,
transmitting said parameters to a predefined gateway over a second network, said gateway wirelessly forwarding said parameters to said medication dispenser device,
receiving tracked and recorded information from said medication dispensing device,.wherein said tracked and recorded information defines the time medication was dispensed in order to provide feedback and control to said administrators.

12. A method of wirelessly communicating medication dispenser parameters for a medication dispenser device registered with a server, as per claim 10, wherein said first and second networks comprise any of the following: a local area network (LAN), a wide area network (WAN), a wireless network, a telephony-based network, or the Internet.

13. A method of wirelessly communicating medication dispenser parameters for a medication dispenser device registered with a server, as per claim 10, wherein said tracked and recorded information further includes one or more of the following: the time a sensor in a pill receiver acknowledges that medication is present in said receiver, the time a sensor in a pill receiver acknowledges that medication is not present in said receiver,

14. A method for retrieving and forwarding medication dispenser parameters via a plurality of gateways dispersed at predetermined remote physical locations, said method comprising the steps of:
establishing a wireless communication link with at least one medication dispenser having a single board computer,
receiving medication dispenser parameters from a server, said medication dispenser parameters comprising one or more of: the type of medication,
quantity of medication, and dispensing schedule of medication; and
wirelessly forwarding said received medication dispenser parameters to said single board computer.

15. A method for retrieving and forwarding medication dispenser parameters via a plurality of gateways dispersed at predetermined physical locations, as per claim 13, wherein said wireless communication is via an IEEE 802.11-based interface.
